(19) United States
(12) Patent Application Publication
(10) Pub. No.: US 2026/0212584 A1
(43) Pub. Date: Jul. 23, 2026

(54) TWO-DIMENSIONAL (2D) RENDERING OF BLOCK-BASED THREE-DIMENSIONAL (3D) RECONSTRUCTION

(71) Applicant: QUALCOMM Incorporated, San Diego, CA (US)

(72) Inventors: Pirazh KHORRAMSHAHI, San Diego, CA (US); Adithya Reddy NALLABOLU, San Diego, CA (US); Upal MAHBUB, El Cajon, CA (US); Mehul ARORA, San Diego, CA (US); Gokce DANE, San Diego, CA (US)

(21) Appl. No.: 19/031,036

(22) Filed: Jan. 17, 2025

(51) Int. Cl. G06T 15/06; G06T 7/50; G06T 7/90; G06T 15/08; G06T 15/20

(52) U.S. Cl. CPC G06T 15/06; G06T 7/50; G06T 7/90; G06T 15/08; G06T 15/20

(57) ABSTRACT

Systems and techniques are described for generating an image. For instance, a processes can include selecting a plurality of voxel blocks for a scene, wherein the plurality of voxel blocks include one or more known locations within a three-dimensional (3D) coordinate system; projecting the plurality of voxel blocks to a two-dimensional (2D) viewpoint based on a camera pose to determine depth information; generating keys for the plurality of voxel blocks based depth information associated with the plurality of voxel blocks and patch identifiers associated with the plurality of voxel blocks; sampling the plurality of voxel blocks based on the keys and the depth information using a ray cast for a pixel of an image to determine a color for the pixel; and outputting the image.

### FIELD

The present disclosure generally relates to three-dimensional (3D) reconstruction. For example, aspects of the present disclosure relate to efficient, real-time, and realistic two-dimensional (2D) rendering of block-based 3D reconstructions.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Traditional systems for constructing 3D models use a significant amount of computational resources, memory, and bandwidth, and in some cases generate significant heat in the process. In recent decades, there has been a demand for 3D content for computer graphics, virtual reality, and communications. Recent decades have also shown a demand for performing more computing tasks on portable computing devices rather than bulky stationary computing systems.

### SUMMARY

Systems and techniques are described for generating an image based on a three-dimensional (3D) reconstruction of a scene. In one illustrative example, an apparatus for generating an image is provided. The apparatus includes at least one memory and at least one processor coupled to the at least one memory. The at least one processor is configured to: select a plurality of voxel blocks for a scene, wherein the plurality of voxel blocks include one or more known locations within a three-dimensional (3D) coordinate system; project the plurality of voxel blocks to a two-dimensional (2D) viewpoint based on a camera pose to determine depth information; generate keys for the plurality of voxel blocks based depth information associated with the plurality of voxel blocks and patch identifiers associated with the plurality of voxel blocks; sample the plurality of voxel blocks based on the keys and the depth information using a ray cast for a pixel of an image to determine a color for the pixel; and output the image.

As another example, a method for generating an image is provided. The method includes: selecting a plurality of voxel blocks for a scene, wherein the plurality of voxel blocks include one or more known locations within a three-dimensional (3D) coordinate system; projecting the plurality of voxel blocks to a two-dimensional (2D) viewpoint based on a camera pose to determine depth information; generating keys for the plurality of voxel blocks based depth information associated with the plurality of voxel blocks and patch identifiers associated with the plurality of voxel blocks; sampling the plurality of voxel blocks based on the keys and the depth information using a ray cast for a pixel of an image to determine a color for the pixel; and outputting the image.

In another example, a non-transitory computer-readable medium having stored thereon instructions is provided. The instructions, when executed by at least one processor, cause the at least one processor to: select a plurality of voxel blocks for a scene, wherein the plurality of voxel blocks include one or more known locations within a three-dimensional (3D) coordinate system; project the plurality of voxel blocks to a two-dimensional (2D) viewpoint based on a camera pose to determine depth information; generate keys for the plurality of voxel blocks based depth information associated with the plurality of voxel blocks and patch identifiers associated with the plurality of voxel blocks; sample the plurality of voxel blocks based on the keys and the depth information using a ray cast for a pixel of an image to determine a color for the pixel; and output the image.

As another example, an apparatus for generating an image is provided. The apparatus includes: means for selecting a plurality of voxel blocks for a scene, wherein the plurality of voxel blocks include one or more known locations within a three-dimensional (3D) coordinate system; means for projecting the plurality of voxel blocks to a two-dimensional (2D) viewpoint based on a camera pose to determine depth information; means for generating keys for the plurality of voxel blocks based depth information associated with the plurality of voxel blocks and patch identifiers associated with the plurality of voxel blocks; means for sampling the plurality of voxel blocks based on the keys and the depth information using a ray cast for a pixel of an image to determine a color for the pixel; and means for outputting the image.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram illustrating an example device that may employ a color metadata buffer for 3D reconstruction, in accordance with some examples.

FIG. 4 is a diagram illustrating an example of a 3D surface reconstruction of a scene modeled as a volume grid, in accordance with some examples.

FIG. 5 is a diagram illustrating an example of a hash mapping function for indexing blocks (e.g., voxel blocks) in a volume grid, in accordance with some examples.

FIG. 6 is a diagram illustrating an example of a block (e.g., a voxel block), in accordance with some examples.

FIG. 7 is a diagram illustrating an example of a truncated signed distance function (TSDF) volume reconstruction, in accordance with some examples.

FIG. 8 is a block diagram illustrating an overall architecture of a system for 2D rendering of block-based 3DR, in accordance with aspects of the present disclosure.

FIG. 9 illustrates an example of ray-casting, in accordance with aspects of the present disclosure.

FIG. 10 is a flow diagram illustrating an algorithm for 2D rendering of block-based 3DR, in accordance with aspects of the present disclosure.

FIG. 11 is a flow diagram illustrating a process for generating an image, in accordance with aspects of the present disclosure.

FIG. 12 is a block diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some cases, 2D images may be rendered to provide a view into the 3DR scene, for example, for visual see through applications where the 3DR scene is based on a physical environment around a device. Traditionally, rendering a 2D image based on a 3DR scene involved performing a surface extraction from the voxel blocks to generate a 3D mesh surface. This 3D mesh surface may be textured based on color information from the voxel blocks. The 3D textured mesh may be rendered to 2D based on a 6DoF pose information (e.g., to provide a viewpoint from which to render the image) of a device, such as a head mounted display, to obtain a 2D rendered image. However, rendering a 2D image based on the 3D textured mesh may look somewhat unrealistic in the absence of a highly detailed mesh (e.g., a mesh with a large number of vertices), which may increase an amount of computational resources used for rendering the image. In some cases, as the voxels may include color information along with location information indicating where the voxel is located in the 3DR scene, it may be more efficient to perform volume rendering to generate the 2D image directly using the information in the voxels without generating the 3D textured mesh.

Systems, apparatuses, electronic devices, methods (also referred to as processes), and computer-readable media (collectively referred to herein as “systems and techniques”) are described herein that provide 2D rendering of block-based 3D reconstructions. For example, a scene may be modeled as a 3D sparse volumetric representation (e.g., referred to as a volume grid) and the volume grid can contain a set of voxel blocks. Each voxel block of the set of voxel blocks is indexed by its respective position in space. In some cases, a plurality of voxel blocks may be selected. The voxel blocks that are selected may be those voxel blocks that include a surface (e.g., of an object) or are located close to a surface. The voxel blocks may have known locations within a 3D coordinate system (e.g., a global coordinate system) and the voxel blocks may include color information (e.g., a color of the surface). The voxel blocks may be generated based on images of the scene along with depth information (e.g., a depth image), along with pose information of camera(s) that captured the images. To generate a 2D image of the 3DR, a pose of a camera (e.g., virtual camera) may be obtained. This camera pose may represent a viewpoint of the 2D image (e.g., from where the 2D image may be generated). In some cases, voxel blocks that may not be visible from the viewpoint may be removed. The voxel blocks may be projected to the viewpoint (e.g., using the camera pose) and depth information may be determined. This depth information may indicate a distance between a voxel block and the viewpoint.

In some cases, the 2D image to be generated may be divided into a set of patches (e.g., portions) of the image. The patches, of the set of patches, may be associated with a patch identifier. In some cases, which patch a voxel block is projected into may be determined and a list of voxel blocks projected into a patch may be generated for the patches. A voxel block that is projected into the patch may be associated with the patch identifier for the patch. In cases where a voxel block is projected into multiple patches, a normalized intersection between the voxel block and the patch may be determined and compared to an overlap threshold to determine which patch to associate the voxel block to.

Keys (e.g., identifiers) may be created for the voxel blocks. A key for a voxel block may be generated based on the depth information and patch identifier associated with a voxel block. For example, the least significant digits (e.g., least significant bits) of the key may be based on the depth information, and the most significant digits of the key may be based on the patch identifier. The keys (and thus voxel blocks) may then be sorted based on depth. For example, a radix sort may be used. The radix sort may sort values (e.g., keys) from the least significant digit to the most significant digit.

For the pixels of the 2D image to be generated, a patch identifier for which a pixel falls in is obtained. A ray may be cast for the pixel (e.g., through the pixel from the camera pose) to the voxel blocks (e.g., in the 3DR) based on the depth information. For example, the sorted keys indicate an order for the voxel blocks for a particular patch and the cast ray may be sampled to determine if the ray has hit a voxel block based on the depth information for the voxel blocks in a particular patch and in the order of the voxel blocks for the particular patch. A color of the pixel may be based on the color information in a voxel block that is hit by the ray. In some cases, alpha blending may be used to compose the pixel along with other pixels of the patch.

Additional aspects of the present disclosure are described in more detail below.

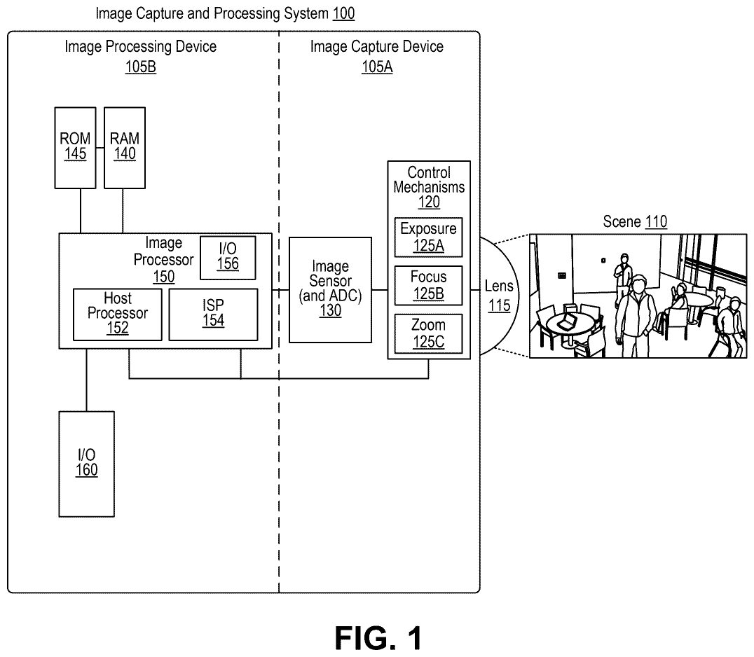

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 2510 discussed with respect to the computing system 2500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2520, read-only memory (ROM) 145/2525, a cache 2512, a memory unit 2515, another storage device 2530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 2535, any other input devices 2545, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the device 105B and one or more peripheral devices, over which the device 105B may receive data from the one or more peripheral device and/or transmit data to the one or more peripheral devices. The I/O devices 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

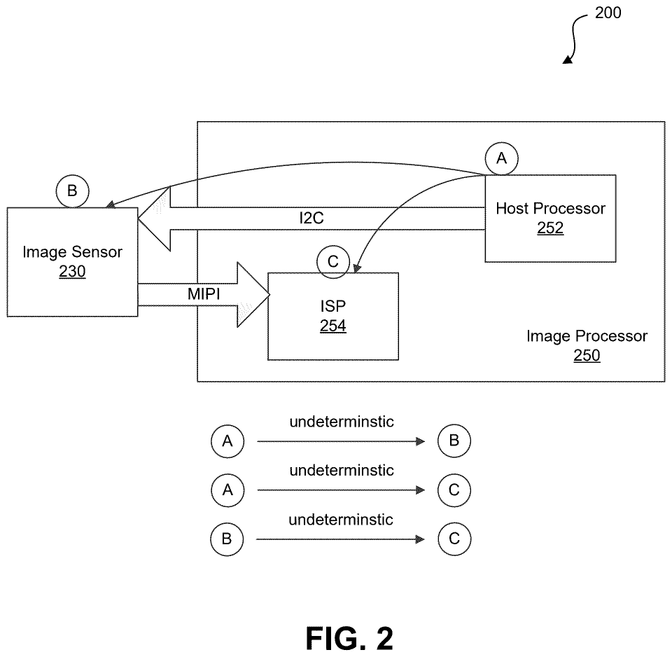

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

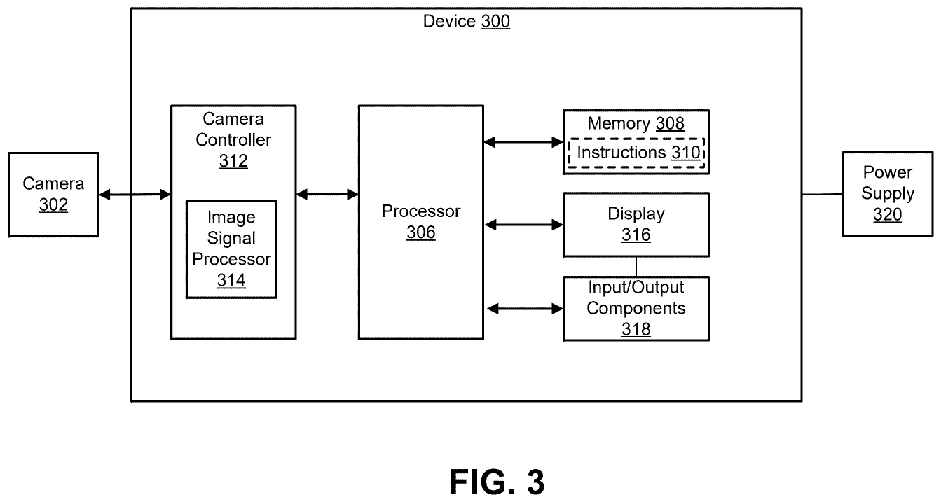

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

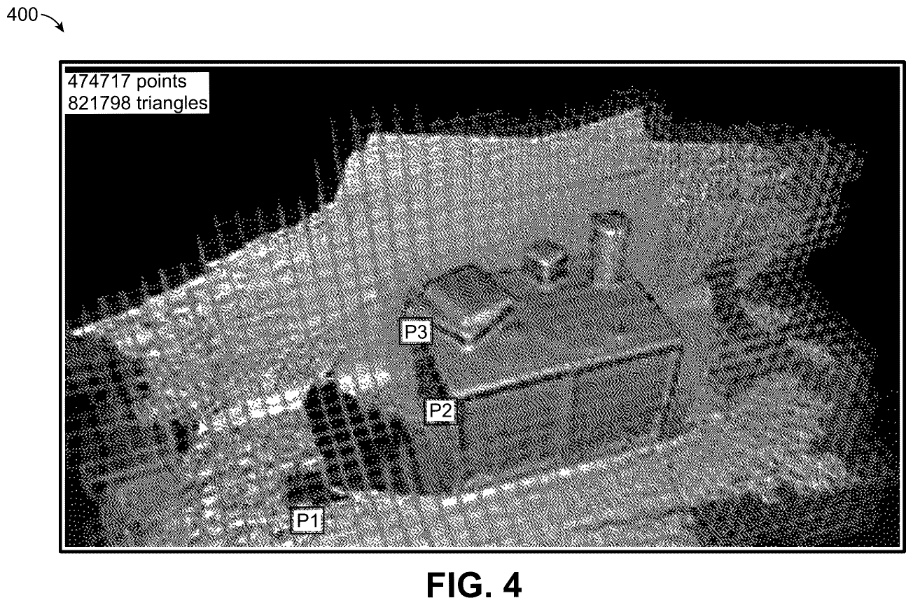

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

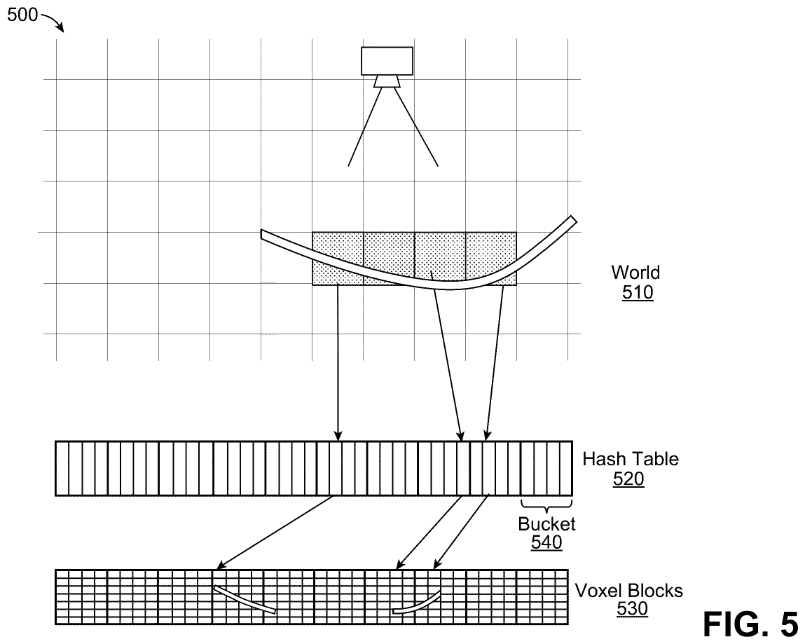

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

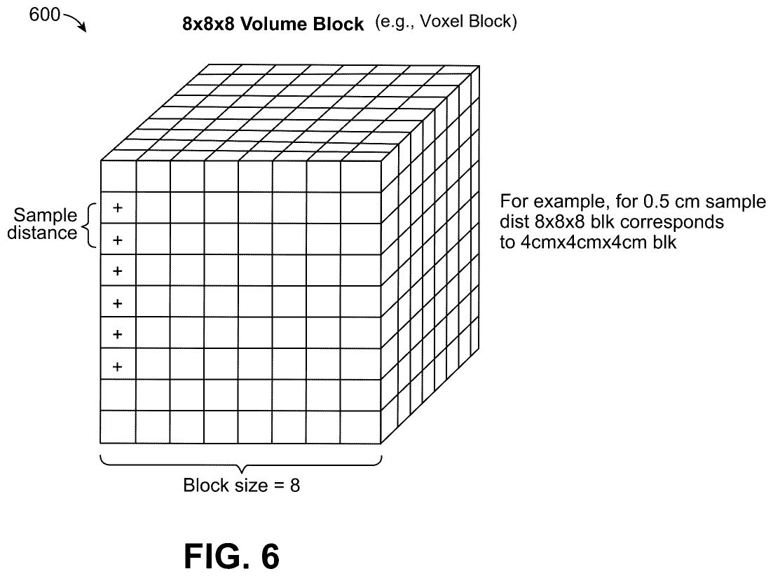

FIG. 6 is a diagram illustrating an example of a volume block (e.g., a voxel block) 600. In FIG. 6, the voxel block 600 is shown to have a block size of eight. For example, a 0.5 centimeter (cm) sample distance for an eight by eight by eight voxel block can correspond to a four cm by four cm by four cm voxel block. That is, the voxel block 600 includes a 3D lattice of 512 voxels, the voxels arranged so that the voxel block 600 has a width of 8 voxels, a length of 8 voxels, and a height of 8 voxels.

In one or more examples, each voxel block (e.g., voxel block 600) can contain or store truncated signed distance function (TSDF) samples and a weight. In some cases, each voxel can also contain or store color values (e.g., red-green-blue (RGB) values) and/or semantic labels (e.g., labels indicating what in the environment is represented by the voxel block). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$tsdf = \{ \begin{matrix}- 1 , & if d \leq - ramp \\ \frac{d}{ramp} , & if - ramp < d < ramp \\ 1 , & if d \geq ramp\end{matrix} \} \qquad Equation ( 1 )$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

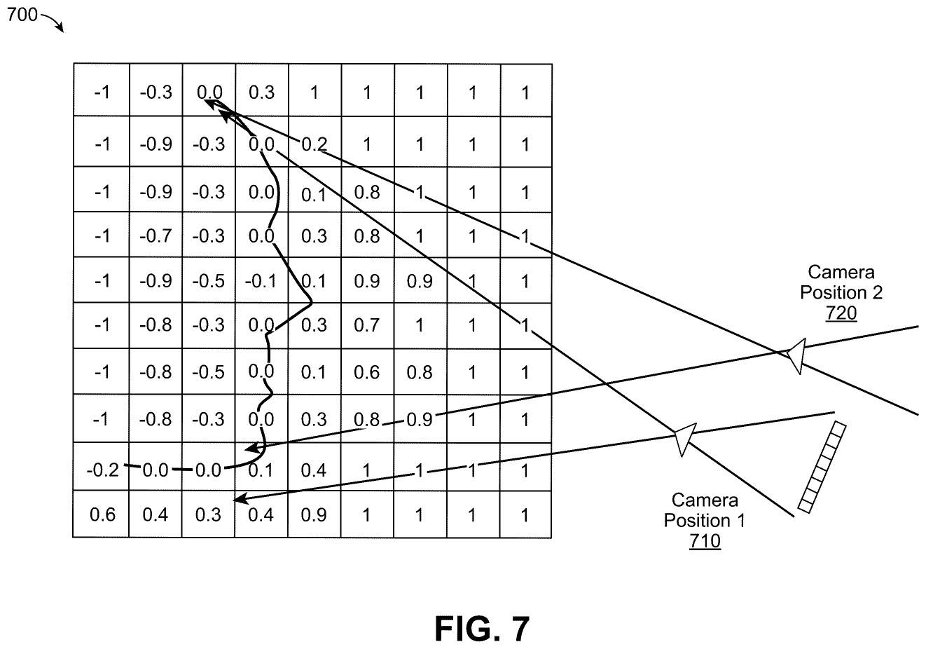

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. In some cases, voxel blocks may carry implicit surface information (e.g., in the form of a TSDF value and a weight for depth integration), along with color information (e.g., RGB information or any other representation of a color of a surface represented by the voxel) and semantic labels. In some cases, a 2D image may be rendered directly based on the voxel blocks using the information contained within the voxel blocks without having to extract a surface, such as a 3D textured mesh, from the voxel blocks to render the 2D image.

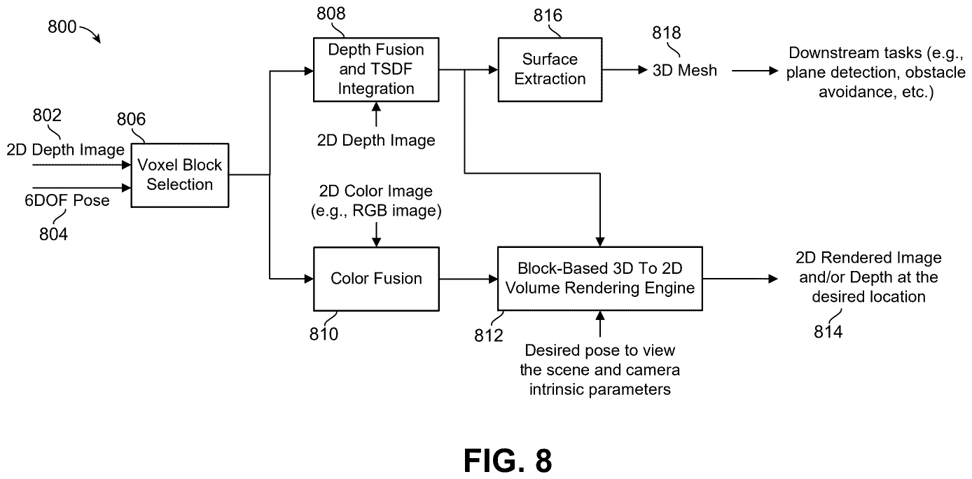

FIG. 8 is a block diagram illustrating an overall architecture 800 of a system for 2D rendering of block-based 3DR, in accordance with aspects of the present disclosure. In FIG. 8, depth images 802, such as those captured using a stereo camera, as described above, or via any other technique for determining depth information for captured images, may be obtained along with 6DoF pose information 804. A depth image 802 may be an image that includes a depth for pixels of the image. The depth images 802 and 6DoF pose information 804 may be used to perform voxel block selection 806. During voxel block selection 806, all of the blocks that have surfaces or are located close to a surface may be selected. Voxel blocks that do not include a surface or are not located close to a surface are not selected. In some cases, voxel block selection 806 may apply a block selection algorithm to select a block if at least one depth pixel is determined to be located in the block. Depth information may be associated with the selected voxel blocks as a part of depth fusion and TSDF integration 808. The selected blocks may also be integrated. For TSDF integration (e.g., block integration), all voxel blocks within a block volume may be iterated over and an updated TSDF value weight can be calculated.

In some cases, color fusion 810 may also be performed. In color fusion 810, color information, such as RGB values associated with pixels of a 2D image (e.g., corresponding to the 2D depth image 802) may be associated with corresponding voxel blocks within the block volume.

Traditionally, output from the color fusion 810 and output from the depth fusion and TSDF integration 808 may be used to perform surface extraction (not shown). For surface extraction, marching cubes may be used to determine triangular surfaces in the blocks to obtain a 3D textured mesh. This 3D textured mesh may then be rendered to 2D based on the 6DoF pose information 804 to obtain a 2D rendered image from a particular location (e.g., viewpoint). However, rendering based on the 3D textured mesh may look somewhat unrealistic. For example, objects in the environment are represented by the 3D mesh, which uses a set of connected triangles. Unless the number of connected triangles is quite high, the object may look blocky and unrealistic. Increasing the number of connected triangles in the 3D mesh can result in more realistic rendering at a cost of a significant amount of additional compute, memory, and/or bandwidth.

As noted above, the voxel blocks may include color information for the volume (e.g., color volume) and it may be more efficient to perform volume rendering to generate the 2D image directly using the information in the voxels without generating the 3D textured mesh. For example, output from the color fusion 810 and output from the depth fusion and TSDF integration 808 may be input to a block-based 3D to 2D volume rendering engine 812, which may render (e.g., generate) a 2D image 814 (or a 2D depth image). The output from the depth fusion and TSDF integration 808 may be separately used to perform surface extraction 816 to generate a 3D mesh 818 that may be used for further downstream operations, such as plane detection, obstacle avoidance, and the like. In cases where the downstream operations are not needed, then generating the 3D mesh 818 may be skipped, thus saving computational resources.

As indicated above, volume rendering to generate the 2D image directly using the information in the voxels without generating the 3D textured mesh may be performed. For example, voxel block selection 806 may be performed to select those voxel blocks which include surfaces or are located close to a surface. These selected voxel blocks may be used as primitives representing the 3D scene as the selected voxel blocks include volumetric information such as geometry in the form of TSDFs, along with color information and semantic labels. In some cases, the volumetric TSDF information and color information may be used with ray casting and alpha blending to render pixels of a 2D image for display. In some cases, alpha blending may be used to combine an image with a background to allow a composite image to be created.

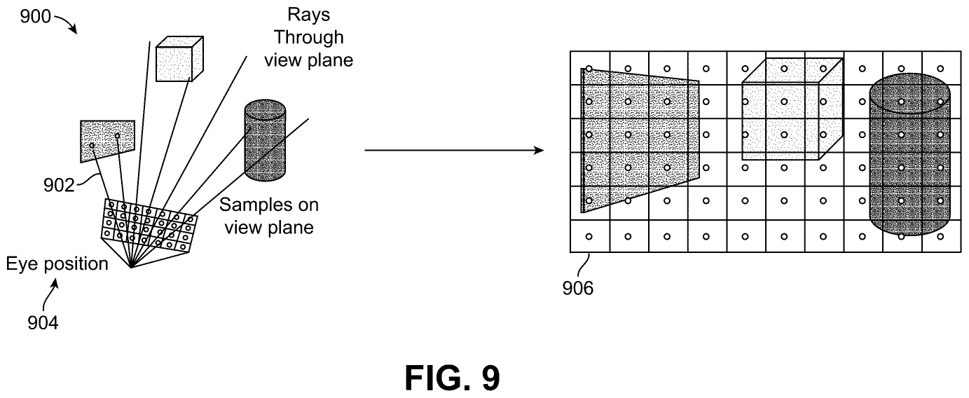

FIG. 9 illustrates an example of ray-casting 900, in accordance with aspects of the present disclosure. In some cases, to determine a perceived color c for a pixel, a ray 902 may be cast from a virtual eye position 904 in a camera center, passing through a pixel of an image 906 (e.g., view) to be rendered into the virtual environment (e.g., 3D volume) as represented by the voxel block. If it is not known whether the cast ray 902 will hit an object, sampling may be performed along the ray 902 at fixed or random intervals. In some cases, the sampling may look at a density of the 3D scene at the sampling interval to determine whether the ray 902 can continue through the 3D scene, or if the ray 902 has hit an object and can be stopped.

The sampling may be performed for N point on the cast ray 902 to evaluate a color cᵢ and a density σᵢ at the sampling point using a Laplacian transformation of the TSDF value at the sample point i to accumulate radiance C, such that

$$C = {\sum }_{i = 1}^{N} {T}_{i} {C}_{i} {α}_{i} ,$$

where αᵢ=(1−e^{-σ}^{ᵢ}^{δ}^{ᵢ}), where

$${T}_{i} = {e}^{- ( {\sum }_{j = 1}^{i = 1} {σ}_{j} {δ}_{j} )} ,$$

where

$${σ}_{i} = \{ \begin{matrix}\frac{1}{2 β} {e}^{\frac{tsdf}{β}} & if tsdf \leq 0 \\ \frac{1}{β} ( 1 - 0.5 {e}^{- \frac{tsdf}{β}} ) & if tsdf > 0\end{matrix} ,$$

and where δ represent a distance on the cast ray 902 between samples, and T represents a transmittance. According to some aspects, the accumulation of radiance C assumes that sample points are sorted with respect to distance from the image 906 (e.g., depth). The accumulated radiance may be used to compost multiple objects in the environment into a single color for the pixel.

In some cases, casting a ray for each pixel to be rendered in an image can be computationally complex. Additionally, multiple points may be sampled along the ray in an order of the depth. While rendering using ray casting benefits from hardware acceleration, rendering algorithm improvements may also be used to provide additional efficiency and/or rendering speed.

As indicated above, a ray may be cast for each pixel of the image 906 to be rendered and one or more points along the ray intersecting with selected voxel blocks to render the image. As multiple points along the ray may be possible, sorting of the blocks according to depth may be used to determine which blocks correspond to which intersection points. In some cases, sorting block according to view-space depth for each pixel can be computational expensive. To avoid block sorting, the image 906 may be split into patches. In some cases, the image 906 may be split into P×P patches. Pixels in a patch may be grouped.

In some cases, it may be useful to take advantage of the sparsity offered by the voxel block. For example, the selected voxel blocks include the blocks that have surfaces or are located close to a surface, and the selected voxel blocks may be projected onto the image 906 (e.g., image plane defined based on a camera pose) based on the viewpoint of the image 906 (e.g., camera pose). The selected voxel blocks may be projected from the 3D representation onto the 2D image 906 as the selected voxel blocks have known locations with respect to a global coordinate system and the viewpoint/camera. By projecting the voxel blocks to the 2D image, the voxel block(s) that fall within a patch can be determined. In some cases, a list of voxel blocks which are projected into a patch may be generated for each patch. For example, each patch may be associated with a patch identifier and each voxel block may be associated with a patch identifier for the patch in which the voxel block appears in the projection. In some cases, depth information may also be determined for each voxel block which appears in the patch. The depth information may be determined as each voxel block has a known location with respect to the viewpoint/camera.

In some cases, each voxel block may be associated with a patch identifier and depth information indicating how far the voxel block is away from the viewpoint/camera. A key or identifier may be generated for a voxel block based on the associated patch identifier and depth information. In some cases, the key may be generated such that the least significant bits (e.g., least significant digits) of the key may represent the depth of the voxel block, and the most significant bits (e.g., highest significant bits) (e.g., least significant digits) of the key may represent the patch identifier.

In some cases, the voxel blocks may be sorted based on the key associated with the voxel blocks. For example, the keys associated with the voxel blocks may be sorted using a radix sort. A radix sort may sort values (e.g., keys) from the least significant bit to the most significant bit (e.g., digit) by distributing digits (e.g., bits) into buckets and repeating for each digit. In some cases, the radix sort may be performed across all of the keys once per frame. In some cases, the radix sort may be parallelized on hardware accelerators, such as a GPU, NPU, DSP, etc. As the radix sort may sort the keys from the least significant bit, which contains the depth information, the radix sort may sort the keys based on the depth into a sorted list of keys.

The voxel block(s) per patch may be extracted from the sorted list (e.g., via the most significant bits) to obtain a sorted set of voxel blocks for a patch. Rays may be cast for the pixels of the patch into the sorted voxel blocks using the known distances (e.g., depth information) and sampling along the ray at intervals may be skipped (e.g., sampling may be performed once based on the known distance). Alpha blending may then be performed within the bounds of the blocks to generate a per-block portion of the image 906. The per-block portions may then be stitched together to form the image 906.

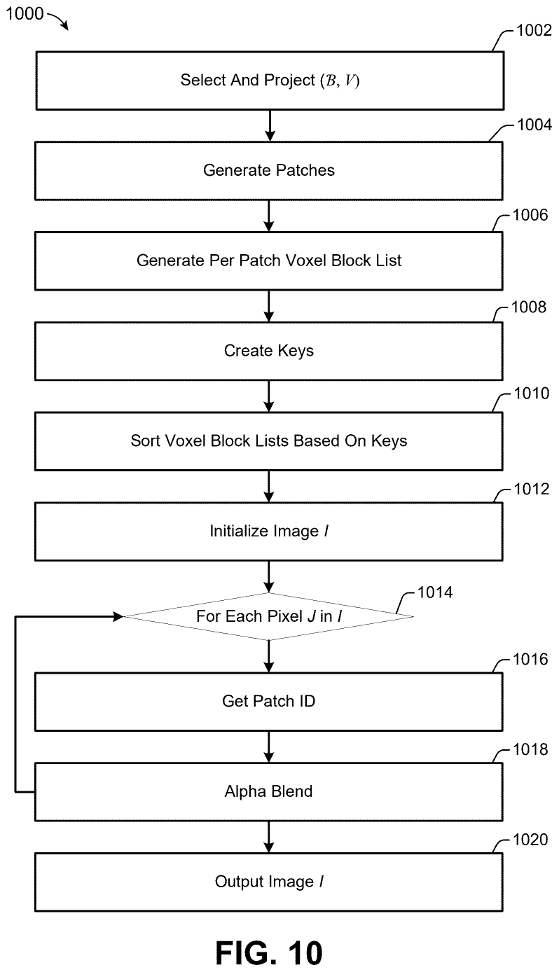

FIG. 10 is a flow diagram illustrating a process 1000 (or algorithm) for 2D rendering of block-based 3DR, in accordance with aspects of the present disclosure. In some cases, the process 1000 to generate the block-based 3DR may be performed by a block-based 3D to 2D volume rendering engine, such as block-based 3D to 2D volume rendering engine 812 of FIG. 8. An image I to be rendered may have an associated height (H) and width (W) for a total of H×W pixels in the image I. A patch size s may be defined based on a number of patches, such as P×P patches. In some cases, the size s of the patch may be tunable to help provide a balance for quality and speed. A camera pose and camera intrinsics V for generating the image may also be defined. The term B may represent a set of all selected 3D voxel blocks (e.g., from voxel block selection 806 of FIG. 8) in the 3DR of the environment. In some cases, an overlap threshold (e.g., represented by γ) may be used, as described in more detail herein.

In some cases, not every voxel block may be visible from the viewpoint of the virtual camera and at step 1002, voxel blocks that are visible from the viewpoint may be selected and projected from the 3DR to an image plane for the image I to be rendered at the viewpoint and the remaining voxel blocks may be put aside. The voxel blocks may be selected based on the camera pose and camera intrinsics V to identify those voxels blocks visible from the viewpoint. In some cases, selecting the voxel blocks may be performed by determining those voxel blocks that are not visible from the viewpoint and removing those voxels blocks that are not visible from a set of selected voxel blocks. For example, based on the camera pose and camera intrinsics V, a camera center and four image corners may be determined for a total of five points. These five points may be unprojected into the 3D space to form a volume or a polygon. The voxel block(s) that fall within the volume/polygon may be selected for processing. The selected voxel blocks may be projected into the image plane based on the camera pose and camera intrinsics V and the known locations of the voxel blocks. For example, the camera pose and location of the voxel blocks may be relative to a global coordinate system and a perspective projection performed based on the image plane determined from the camera pose. In some cases, a depth information (e.g., how far away the voxel blocks are from the image plane and/or/camera) for the voxel blocks may be determined as a part of projecting the voxels blocks into 2D.

At step 1004, patches may be generated. In some cases, the patches may be generated based on the patch size s along with the H×W for pixels in the image I. At step 1006, a list of voxel blocks which are projected into a patch may be generated. For example, if two voxel blocks, when projected into 2D fall within a particular patch, the two voxel blocks may be included in a voxel block list associated with the particular patch. The voxel block list for a patch may indicate which voxel blocks appear in the patch. In some cases, each patch may have an identifier and voxel blocks may be associated with patch identifiers of the patch in which the voxel blocks fall in. Voxel block lists may be generated for each patch of the image I.

In some cases, when projecting from 3D to 2D, a single voxel block may fall in multiple patches. In such cases, the voxel block may be assigned into a patch that the voxel block mostly falls into. For example, a normalized intersection of the voxel block and the multiple patches may be determined. The normalized intersection of the voxel block and a patch may be compared to the overlap threshold γ to determine whether the voxel block appears in the patch. For example, if the normalized intersection between the voxel block and the patch is above the overlap threshold γ, then the voxel block may be considered to fall in that patch. In some cases, the overlap threshold γ may be a tunable parameter. As another example, the normalized intersection of the voxel block and the patch may be compared to the overlap threshold γ. If the normalized intersection between the voxel block and the patch is above the overlap threshold γ, then the voxel block may be duplicated and the voxel block may be determined to fall into each patch the normalized intersection is above the overlap threshold γ.

At step 1008, keys for the voxel blocks may be created. In some cases, keys may be created for each voxel block in the voxel block lists. The keys may be created based on the associated block identifier and depth information. For example, key may be created such that the least significant bits of the key may represent the depth of the voxel block, and the most significant bits of the key may represent the patch identifier. At step 1010, the voxel blocks may be sorted based on their associated key to generate a sorted list of voxel blocks. In some cases, the keys and associated voxel blocks may be sorted using a radix sort such that the voxel blocks are sorted based on the depth of the voxel blocks. The voxel blocks may be sorted based on depth once per frame. In some cases, the radix sort may be parallelized.

At step 1012, the image I may be initialized. In some cases, the initialized image I may be blank and color values for each pixel of the initialized image I may be assigned. At step 1014, the pixels for image I may be looped through to determine color values for the pixels. For the pixels of the image I, at step 1016, a patch identifier associated with the pixel may be obtained. As the image I is divided into patches, each pixel may be associated with a particular patch where the pixel is located. At step 1018, alpha blending may be performed on the pixel. For example, based on the patch identifier, the voxel blocks which fall into the patch can be identified from the sorted list of voxel blocks to generate assorted set of voxel blocks for the patch. A ray may be cast into the 3DR using the voxel blocks in the sorted list of voxel blocks based on the depth information for the voxel blocks. Based on the voxel block that the cast ray hits, color information for the pixel may be obtained. Alpha blending may be performed to blend the color information of the pixel with other pixels of the patch.

In some cases, step 1016 and step 1018 may be repeated for each pixel J in image I. After the pixels are processed, the image/may be output at step 1020.

In some cases, the techniques for 2D rendering of block-based 3DR, as described above, may provide realistic renderings from a 3DR efficiently in real-time independent of (e.g., without relying on) a 3D mesh as used by other approaches for 2D rendering. In cases where the 2D rendering is the desired output, computation of the 3D mesh may be omitted to save computational costs.

As compared to other techniques for 2D rendering, such as gaussian splatting, gaussian splatting may operate on images of a scene expressed as a point cloud, allowing the scene to be represented using 3D gaussians to model radiance fields. Typically, dedicated training sessions on, for example, images of the scene, may be used to generate, prune, and/or conform gaussian splats to ensure multi-view consistency and to capture the geometry and visual details. Once trained, a gaussian splatting model of the scene may be fixed and the gaussian splatting model may have a large (e.g., millions) of gaussians to describe details about the scene. Each gaussian may be described with a color value, regardless of the size of the gaussian. In contrast, the block-based techniques described above may not use a training session. Also, surfaces may be detected in images and color information may be accumulated on the fly as input images are received. Additionally, as only blocks around surfaces in the scene may be stored, a total number of blocks may be significantly lower as compared the number of gaussian splats for a scene. Additionally, blocks may have fixed dimensions and may be aligned with axes of a world coordinate system, as compared to gaussian splats, which may include feature values that indicate how a particular gaussian splat is oriented in 3D space.

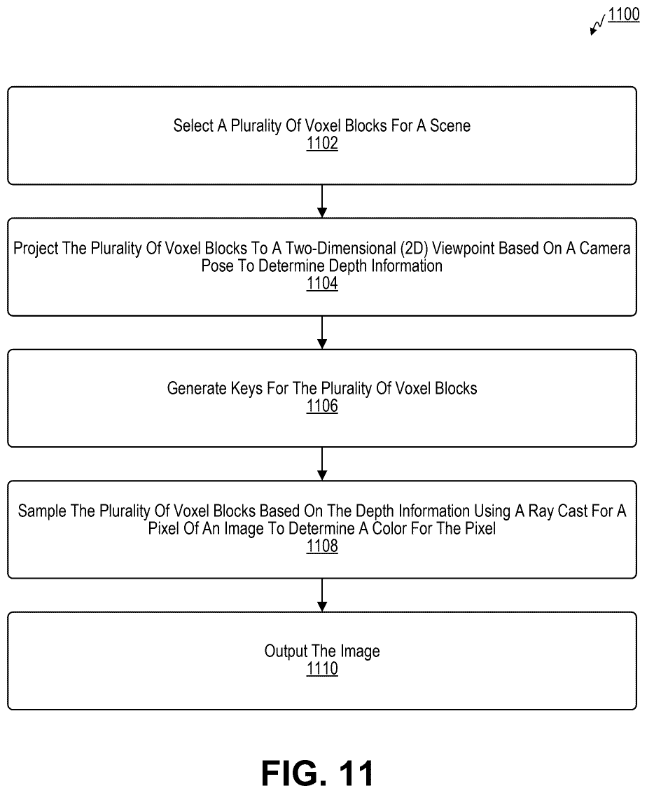

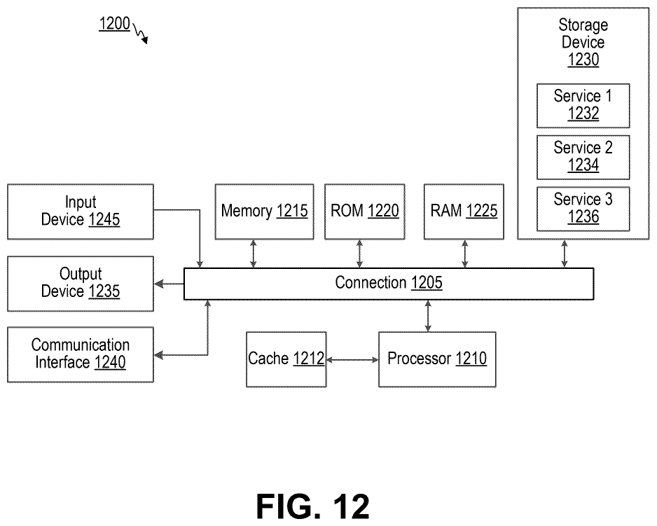

FIG. 11 is a flow diagram illustrating a process 1100 for generating an image, in accordance with aspects of the present disclosure. The process 1100 may be performed by a computing device (or apparatus) or a component (e.g., a chipset, codec, etc.) of the computing device (e.g., image capturing and processing system 100 of FIG. 1, image capture and processing system 200 of FIG. 2, device 300 of FIG. 3, computing system 1200 of FIG. 12, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors (e.g., the image processor 150 of FIG. 1, the host processor 152 of FIG. 1, image processor 250 of FIG. 2, host processor 252 of FIG. 2, processor 306 of FIG. 3, ISP 314 of FIG. 3, processor 1210 of FIG. 12, and/or other processor(s)). In some cases, the operations of the process 1100 can be implemented by a system having the architecture of computing system 1200 of FIG. 12.

At block 1102, the computing device (or component thereof) may select a plurality of voxel blocks (e.g., voxel blocks 530 of FIG. 5, voxel block 600 of FIG. 6, etc.) for a scene (e.g., as a part of voxel block selection 806 of FIG. 8). In some cases, the plurality of voxel blocks includes one or more known locations within a three-dimensional (3D) coordinate system. In some examples, the computing device (or component thereof) may generate a set of patches (e.g., at step 1004 of FIG. 10) for the image, determine which voxel blocks of the plurality of voxel blocks are projected into which patches of the set of patches to generate a list of voxel blocks projected into a patch (e.g., at step 1004 of FIG. 10), and associate a voxel block, of the list of voxel blocks projected into the patch, with a patch identifier associated with the patch. In some cases, each patch of the set of patches is associated with a respective patch identifier. In some examples, the set of patches is generated based on a patch size. In some cases, the computing device (or component thereof) may select the plurality of voxel blocks by removing one or more voxel blocks of the plurality of voxel blocks that are not visible from the 2D viewpoint. In some examples, the plurality of voxel blocks is generated based on a received depth image.

At block 1104, the computing device (or component thereof) may project the plurality of voxel blocks to a two-dimensional (2D) viewpoint based on a camera pose (e.g., 6DoF pose information 804 of FIG. 8) to determine depth information. In some cases, the computing device (or component thereof) may determine the voxel block is projected into multiple patches of the set of patches and determine which patch of the multiple patches to associate the voxel block with based on a comparison of an overlap threshold and a normalized intersection between the voxel block and the patch. In some examples, the computing device (or component thereof) may determine which patch of the multiple patches to associate the voxel block with by determining the voxel block falls into two or more patches of the multiple patches, and duplicating the voxel block into the two or more patches of the multiple patches.

At block 1106, the computing device (or component thereof) may generate keys (e.g., at step 1008 of FIG. 10) for the plurality of voxel blocks based depth information associated with the plurality of voxel blocks and patch identifiers associated with the plurality of voxel blocks. In some cases, least significant bits of the keys are based on the depth information, and most significant bits of the keys are based on the patch identifiers. In some examples, the depth information indicates a depth between the 2D viewpoint and the plurality of voxel blocks.

At block 1108, the computing device (or component thereof) may sample the plurality of voxel blocks based on the keys and the depth information using a ray (e.g., ray 902 of FIG. 9) cast for a pixel of an image (e.g., image 906 of FIG. 9) to determine a color for the pixel. In some cases, the computing device (or component thereof) may sample the plurality of voxel blocks based on the keys by sorting the keys and sampling the plurality of voxel blocks based on the sorted keys. In some examples, the computing device (or component thereof) may sort the keys using a radix sort. For example, the radix sort may sort values (e.g., keys) from the least significant bit to the most significant bit.

At block 1110, the computing device (or component thereof) may output the image. In some cases, the computing device (or component thereof) may perform alpha blending for pixels in the patch (e.g., at step 1018 of FIG. 10).

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus May include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1100 and/or other processes described herein may include a processor, microprocessor, micro-computer, or other component of a device that is configured to carry out the steps of the process 1100 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1100 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 is illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1100 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a block diagram illustrating an example of a computing system 1200, which may be employed for a scalable voxel block selection algorithm with a finite hardware cache. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory (e.g., memory unit 1215), such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LIDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for generating an image, the apparatus comprising: at least one memory; and at least one processor coupled to the at least one memory and configured to: select a plurality of voxel blocks for a scene, wherein the plurality of voxel blocks include one or more known locations within a three-dimensional (3D) coordinate system; project the plurality of voxel blocks to a two-dimensional (2D) viewpoint based on a camera pose to determine depth information; generate keys for the plurality of voxel blocks based depth information associated with the plurality of voxel blocks and patch identifiers associated with the plurality of voxel blocks; sample the plurality of voxel blocks based on the keys and the depth information using a ray cast for a pixel of an image to determine a color for the pixel; and output the image.

Aspect 2. The apparatus of Aspect 1, wherein, to sample the plurality of voxel blocks based on the keys, the at least one processor is further configured to: sort the keys; and sample the plurality of voxel blocks based on the sorted keys.

Aspect 3. The apparatus of Aspect 2, wherein the at least one processor is configured to sort the keys using a radix sort.

Aspect 4. The apparatus of any of Aspects 1-3, wherein the at least one processor is further configured to: generate a set of patches for the image, wherein each patch of the set of patches is associated with a respective patch identifier; determine which voxel blocks of the plurality of voxel blocks are projected into which patches of the set of patches to generate a list of voxel blocks projected into a patch; and associate a voxel block, of the list of voxel blocks projected into the patch, with a patch identifier associated with the patch.

Aspect 5. The apparatus of Aspect 4, wherein the at least one processor is configured to perform alpha blending for pixels in the patch.

Aspect 6. The apparatus of any of Aspects 4-5, wherein the at least one processor is configured to: determine the voxel block is projected into multiple patches of the set of patches; and determine which patch of the multiple patches to associate the voxel block with based on a comparison of an overlap threshold and a normalized intersection between the voxel block and the patch.

Aspect 7. The apparatus of Aspect 6, wherein, to determine which patch of the multiple patches to associate the voxel block with, the at least one processor is configured to: determine the voxel block falls into two or more patches of the multiple patches; and duplicate the voxel block into the two or more patches of the multiple patches.

Aspect 8. The apparatus of any of Aspects 4-7, wherein the set of patches is generated based on a patch size.

Aspect 9. The apparatus of any of Aspects 1-8, wherein least significant bits of the keys are based on the depth information, and wherein most significant bits of the keys are based on the patch identifiers.

Aspect 10. The apparatus of any of Aspects 1-9, wherein the depth information indicates a depth between the 2D viewpoint and the plurality of voxel blocks.

Aspect 11. The apparatus of any of Aspects 1-10, wherein the at least one processor is configured to select the plurality of voxel blocks by removing one or more voxel blocks of the plurality of voxel blocks that are not visible from the 2D viewpoint.

Aspect 12. The apparatus of any of Aspects 1-11, wherein the plurality of voxel blocks is generated based on a received depth image.

Aspect 13. A method for generating an image, comprising: selecting a plurality of voxel blocks for a scene, wherein the plurality of voxel blocks include one or more known locations within a three-dimensional (3D) coordinate system; projecting the plurality of voxel blocks to a two-dimensional (2D) viewpoint based on a camera pose to determine depth information; generating keys for the plurality of voxel blocks based depth information associated with the plurality of voxel blocks and patch identifiers associated with the plurality of voxel blocks; sampling the plurality of voxel blocks based on the keys and the depth information using a ray cast for a pixel of an image to determine a color for the pixel; and outputting the image.

Aspect 14. The method of Aspect 13, wherein sampling the plurality of voxel blocks based on the keys comprises: sorting the keys; and sampling the plurality of voxel blocks based on the sorted keys.

Aspect 15. The method of Aspect 14, further comprising sorting the keys using a radix sort.

Aspect 16. The method of any of Aspects 13-15, further comprising: generating a set of patches for the image, wherein each patch of the set of patches is associated with a respective patch identifier; determining which voxel blocks of the plurality of voxel blocks are projected into which patches of the set of patches to generate a list of voxel blocks projected into a patch; and associating a voxel block, of the list of voxel blocks projected into the patch, with a patch identifier associated with the patch.

Aspect 17. The method of Aspect 16, further comprising perform alpha blending for pixels in the patch.

Aspect 18. The method of any of Aspects 16-17, further comprising: determining the voxel block is projected into multiple patches of the set of patches; and determining which patch of the multiple patches to associate the voxel block with based on a comparison of an overlap threshold and a normalized intersection between the voxel block and the patch.

Aspect 19. The method of Aspect 18, wherein determining which patch of the multiple patches to associate the voxel block with comprises: determining the voxel block falls into two or more patches of the multiple patches; and duplicating the voxel block into the two or more patches of the multiple patches.

Aspect 20. The method of any of Aspects 16-19, wherein the set of patches is generated based on a patch size.

Aspect 21. The method of any of Aspects 13-20, wherein least significant bits of the keys are based on the depth information, and wherein most significant bits of the keys are based on the patch identifiers.

Aspect 22. The method of any of Aspects 13-21, wherein the depth information indicates a depth between the 2D viewpoint and the plurality of voxel blocks.

Aspect 23. The method of any of Aspects 13-22, further comprising selecting the plurality of voxel blocks by removing one or more voxel blocks of the plurality of voxel blocks that are not visible from the 2D viewpoint.

Aspect 24. The method of any of Aspects 13-23, wherein the plurality of voxel blocks is generated based on a received depth image.

Aspect 25. A non-transitory computer-readable medium having stored thereon instructions that, when executed by one or more processors, cause the one or more processors to perform operations according to any of Aspects 13 to 24.

Aspect 26. An apparatus for generating an image, the apparatus comprising one or more means for performing operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for generating an image, the apparatus comprising:
at least one memory; and
at least one processor coupled to the at least one memory and configured to:
select a plurality of voxel blocks for a scene, wherein the plurality of voxel blocks include one or more known locations within a three-dimensional (3D) coordinate system;
project the plurality of voxel blocks to a two-dimensional (2D) viewpoint based on a camera pose to determine depth information;
generate keys for the plurality of voxel blocks based depth information associated with the plurality of voxel blocks and patch identifiers associated with the plurality of voxel blocks;
sample the plurality of voxel blocks based on the keys and the depth information using a ray cast for a pixel of an image to determine a color for the pixel; and
output the image.

2. The apparatus of claim 1, wherein, to sample the plurality of voxel blocks based on the keys, the at least one processor is further configured to:
sort the keys; and
sample the plurality of voxel blocks based on the sorted keys.

3. The apparatus of claim 2, wherein the at least one processor is configured to sort the keys using a radix sort.

4. The apparatus of claim 1, wherein the at least one processor is further configured to:
generate a set of patches for the image, wherein each patch of the set of patches is associated with a respective patch identifier;
determine which voxel blocks of the plurality of voxel blocks are projected into which patches of the set of patches to generate a list of voxel blocks projected into a patch; and
associate a voxel block, of the list of voxel blocks projected into the patch, with a patch identifier associated with the patch.

5. The apparatus of claim 4, wherein the at least one processor is configured to perform alpha blending for pixels in the patch.

6. The apparatus of claim 4, wherein the at least one processor is configured to:
determine the voxel block is projected into multiple patches of the set of patches; and
determine which patch of the multiple patches to associate the voxel block with based on a comparison of an overlap threshold and a normalized intersection between the voxel block and the patch.

7. The apparatus of claim 6, wherein, to determine which patch of the multiple patches to associate the voxel block with, the at least one processor is configured to:
determine the voxel block falls into two or more patches of the multiple patches; and
duplicate the voxel block into the two or more patches of the multiple patches.

8. The apparatus of claim 4, wherein the set of patches is generated based on a patch size.

9. The apparatus of claim 1, wherein least significant bits of the keys are based on the depth information, and wherein most significant bits of the keys are based on the patch identifiers.

10. The apparatus of claim 1, wherein the depth information indicates a depth between the 2D viewpoint and the plurality of voxel blocks.

11. The apparatus of claim 1, wherein the at least one processor is configured to select the plurality of voxel blocks by removing one or more voxel blocks of the plurality of voxel blocks that are not visible from the 2D viewpoint.

12. The apparatus of claim 1, wherein the plurality of voxel blocks is generated based on a received depth image.

13. A method for generating an image, comprising:
selecting a plurality of voxel blocks for a scene, wherein the plurality of voxel blocks include one or more known locations within a three-dimensional (3D) coordinate system;
projecting the plurality of voxel blocks to a two-dimensional (2D) viewpoint based on a camera pose to determine depth information;
generating keys for the plurality of voxel blocks based depth information associated with the plurality of voxel blocks and patch identifiers associated with the plurality of voxel blocks;
sampling the plurality of voxel blocks based on the keys and the depth information using a ray cast for a pixel of an image to determine a color for the pixel; and
outputting the image.

14. The method of claim 13, wherein sampling the plurality of voxel blocks based on the keys comprises:
sorting the keys; and
sampling the plurality of voxel blocks based on the sorted keys.

15. The method of claim 14, further comprising sorting the keys using a radix sort.

16. The method of claim 13, further comprising:
generating a set of patches for the image, wherein each patch of the set of patches is associated with a respective patch identifier;
determining which voxel blocks of the plurality of voxel blocks are projected into which patches of the set of patches to generate a list of voxel blocks projected into a patch; and
associating a voxel block, of the list of voxel blocks projected into the patch, with a patch identifier associated with the patch.

17. The method of claim 16, further comprising perform alpha blending for pixels in the patch.

18. The method of claim 16, further comprising:
determining the voxel block is projected into multiple patches of the set of patches; and
determining which patch of the multiple patches to associate the voxel block with based on a comparison of an overlap threshold and a normalized intersection between the voxel block and the patch.

19. The method of claim 18, wherein determining which patch of the multiple patches to associate the voxel block with comprises:
determining the voxel block falls into two or more patches of the multiple patches; and
duplicating the voxel block into the two or more patches of the multiple patches.

20. The method of claim 13, wherein least significant bits of the keys are based on the depth information, and wherein most significant bits of the keys are based on the patch identifiers.
